(19) United States
(12) Patent Application Publication
(10) Pub. No.: US 2019/0321701 A1
(43) Pub. Date: Oct. 24, 2019

(54) SHOCK-ABSORPTION GOALKEEPER ICE-HOCKEY STICK AND SHOCK TEST METHOD THEREOF

(71) Applicants: Joseph HSU, ZHONGSHAN CITY (CN); ZHONGSHAN FUDA SPORTS APP CO., LTD., ZHONGSHAN CITY (CN)

(72) Inventor: Joseph HSU, TAICHUNG CITY (TW)

(21) Appl. No.: 16/390,664

(22) Filed: Apr. 22, 2019

(30) Foreign Application Priority Data
Apr. 23, 2018 (CN) 201810364246.5

(51) Int. Cl. A63B 59/70; A63B 60/08; A63B 60/42; G01M 7/08; A63B 60/54

(52) U.S. Cl. CPC A63B 59/70; A63B 60/08; A63B 2102/24; G01M 7/08; A63B 60/54; A63B 60/42

(57) ABSTRACT

The invention discloses a shock-absorption goalkeeper ice-hockey stick and a shock test method thereof. The shock-absorption goalkeeper ice-hockey stick comprises a stick handle and a baffle plate. A first wood block is tightly inserted into one end of the stick handle. A second wood block is tightly inserted into the other end of the stick handle. An outer surface of the first wood block and second wood block are coated with first silicone. An end, away from the stick handle, of the first wood block is fixedly inserted into the baffle plate. So the sense of shock of the stick handle is greatly reduced, and thus, an impact to the wrists and elbows of players is greatly reduced in the goalkeeping and puck blocking process, and the shock-absorption goalkeeper ice-hockey stick can be used more safely and comfortably.

### BACKGROUND OF THE INVENTION

### 1. Technical Field

The invention relates to the technical field of sports equipment, in particular to a shock-absorption goalkeeper ice-hockey stick and a shock test method thereof.

### 2. Description of Related Art

Shock-absorption goalkeeper ice-hockey sticks are nowadays used by players to block or keep pucks in ice hockey matches and are formed by a stick handle and a baffle plate, wherein the joint of the stick handle and the baffle plate is to be held by the players with hand, and the whole goalkeeper ice-hockey sticks are used to block pucks. Exiting goalkeeper ice-hockey sticks are formed in such a manner: a stick handle is made from fiber resin first, then foam is injected into the stick handle, and finally, fiber resin is laminated onto the stick handle. The goalkeeper ice-hockey sticks of such structure are good in strength, but poor in shock-absorption property. When a puck is hit towards the goalkeeper ice-hockey sticks at a high speed, a strong sense of shock will be generated while the puck is blocked, and is then directly transmitted to the hands of the players, and consequentially, discomfort and even injuries to the wrists and elbows of the players are caused.

### BRIEF SUMMARY OF THE INVENTION

### Technical Issue to be Settled by the Invention

The objective of the invention is to provide a shock-absorption goalkeeper ice-hockey stick and a shock test method thereof, so as to solve the problems, caused by the poor shock-absorption property of existing goalkeeper ice-hockey sticks, that when a puck is hit towards the goalkeeper ice-hockey sticks at a high speed, a strong sense of shock is generated while the puck is blocked, and is then directly transmitted to the hands of players, which in turns results in discomfort and even injuries to the wrists and elbows of the players. The goalkeeper ice-hockey stick manufactured by process improvements is good in shock-absorption property, capable of being used more safely and comfortably, capable of stopping a puck coming over at a high speed and capable of controlling the drop point of the puck more easily, and thus, the players can have a better performance.

### Technical Solution

The technical solutions adopted by the invention to fulfill the above objective are as follows:

According to one solution, a shock-absorption goalkeeper ice-hockey stick comprises a stick handle and a baffle plate. A first wood block is tightly inserted into one end of the stick handle. A second wood block is tightly inserted into the other end of the stick handle. An outer surface of the first wood block is coated with first silicone. An outer surface of the second wood is coated with second silicone. An end, away from the stick handle, of the first wood block is fixedly inserted into the baffle plate.

Furthermore, the first wood block and the second wood block are made from cork wood or foamed wood.

Furthermore, foam is injected into the stick handle, and fiber cloth is laminated onto the foam.

According to another solution, a shock test method of the shock-absorption goalkeeper ice-hockey stick comprises the following steps:

Step 1, correspondingly selecting four points from the first wood block, the second wood block, the stick handle and the baffle plate of the whole goalkeeper ice-hockey stick, and respectively marking the four points as point A, point B, point C and point D;

Step 2, touching point A on the first wood block by a sensor connected to a shock tester;

Step 3, knocking, by a hard object, point B, point C and point D, recording a shock test chart formed on the shock tester when each of point B, point C and point D are knocked, and respectively marking the shock test charts as a shock test chart of point B, a shock test chart of point C and a shock test chart of point D; and

Step 4, comparing and analyzing the shock test charts obtained in Step 3 with shock test charts of corresponding points of an existing goalkeeper ice-hockey stick.

Furthermore, point A, point B, point C and point D in are randomly selected from the corresponding parts in Step 1.

### Beneficial Effects

By adoption of the above technical solutions, the invention the following remarkable advantages against the prior art:

The wood blocks having a good shock-absorption property are inserted into the joint of the stick handle and the baffle plate and into the tail end of the stick handle, and the surfaces of the wood blocks are coated with silicone to further facilitate shock absorption, so that a sense of shock generated when a puck hits against the baffle plate is buffered by the wood blocks and the silicone and is then transmitted to the stick handle, the sense of shock of the stick handle is greatly reduced, and thus, an impact to the wrists and elbows of players is greatly reduced in the goalkeeping and puck blocking process, and the shock-absorption goalkeeper ice-hockey stick can be used more safely and comfortably. In addition, a puck coming over at a high speed can be stopped, the drop point of the puck can be controlled more easily, and the players can have a better performance.

### BRIEF DESCRIPTION OF THE SEVERAL VIEWS OF THE DRAWINGS

FIG. 1 is a structural view of the invention;

FIG. 2 is an A-A sectional view of the invention;

FIG. 3 is a distribution diagram of point A, point B, point C and point D of the invention;

FIG. 4 is diagram of shock test results of point B, point C and point D of the invention; and

FIG. 5 is a diagram of shock test results of three corresponding points of an existing goalkeeper ice-hockey stick.

### DETAILED DESCRIPTION OF THE INVENTION

For a better understanding of the contents of the invention, the invention is expounded below with reference to the accompanying drawings and embodiments.

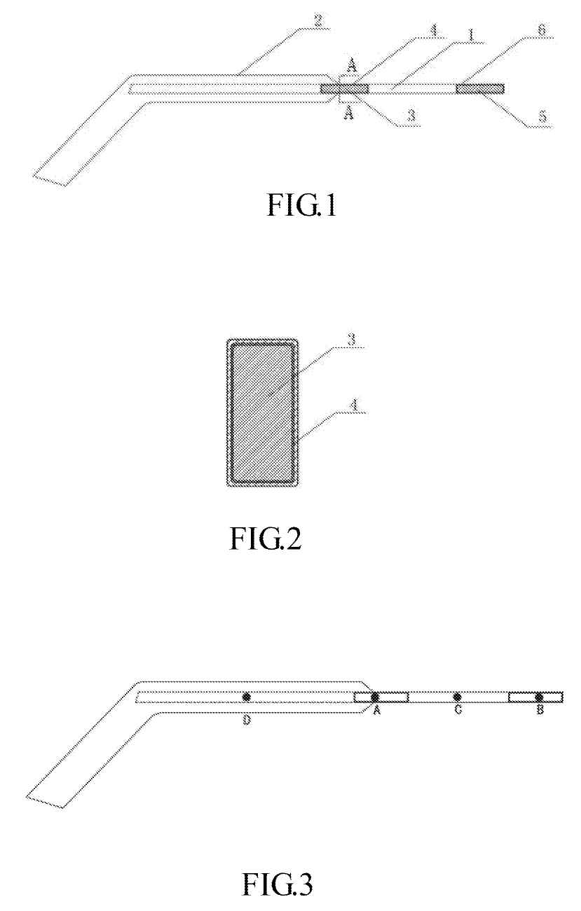

Referring to FIGS. 1-2, a shock-absorption goalkeeper ice-hockey stick comprises a stick handle 1 and a baffle plate 2. The stick handle 1 is formed by heating epoxy resin and fibers through a mold. A first wood block 3 is tightly inserted into one end of the stick handle 1, and a second wood block 5 is tightly inserted into the other end of the stick handle 1. The wood blocks are respectively inserted into an area which is to be held by players with hand and a tail area which is likely to hit against a post, of the stick handle 1. An outer surface of the first wood block 3 is coated with first silicone 4. An outer surface of the second wood block 5 is coated with second silicone 6. Similar silicone films can serve as the first silicone 4 and the second silicone 6. The first wood block 3 and the second wood block 5 are made from cork wood or foamed wood which has a good shock-absorption property. The first wood block 3 and the second wood block 5 can also be made from other materials as needed. The silicone also has a good shock-absorption effect, so that the ice-hockey stick has a good shock-absorption effect. An end, away from the stick handle 1, of the first wood 3 is fixedly inserted into the baffle plate 2. Foam is injected into the stick handle 1, and fiber cloth is laminated onto the foam, so that the novel shock-absorption goalkeeper ice-hockey stick is obtained.

Manufacturing process: epoxy resin and fibers are heated through a mold to form the stick handle 1; two small pieces of wood are cut according to a desired size and a desired shape, and then the first silicone 4 and second silicone 6 are evenly smeared on the first wood block 3 and the second wood block 5 separately and stand to be hardened, so that a shock-absorption effect is realized; the first wood block 3 and the second wood block 5 are tightly inserted into corresponding positions of an inner wall of the stick handle 1; afterwards, foam is injected into the stick handle 1; and finally, the fiber cloth is laminated onto the foam, so that the novel shock-absorption goalkeeper ice-hockey stick is obtained.

Referring to FIG. 3, a shock test method of the shock-absorption goalkeeper ice-hockey stick comprises the following steps:

Step 1, four points which are separately marked as point A, point B, point C and point D are selected from the first wood block 3, the second wood block 5, the stick handle 1 and the baffle plate 2 of the whole goalkeeper ice-hockey stick, wherein point A is a shock sensing point and is also a hand point, point B, point C and point D are knock points, and point A, point B, point C and point D are randomly selected from the corresponding parts so as to ensure the accuracy of test results;

Step 2, a sensor connected to a shock tester touches point A on the first wood block 3;

Step 3, point B, point C and point D are knocked by a hard object, a shock generated when point B, point C and point D are separately knocked is transmitted to hand point A, and shock test charts formed on the shock tester when the three points are knocked are recorded and are marked as a shock test chart of point B, a shock test chart of point C and a shock test chart of point D; and

Step 4, the shock test charts obtained in Step 3 and shock test charts of corresponding points of an existing goalkeeper ice-hockey stick are compared and analyzed.

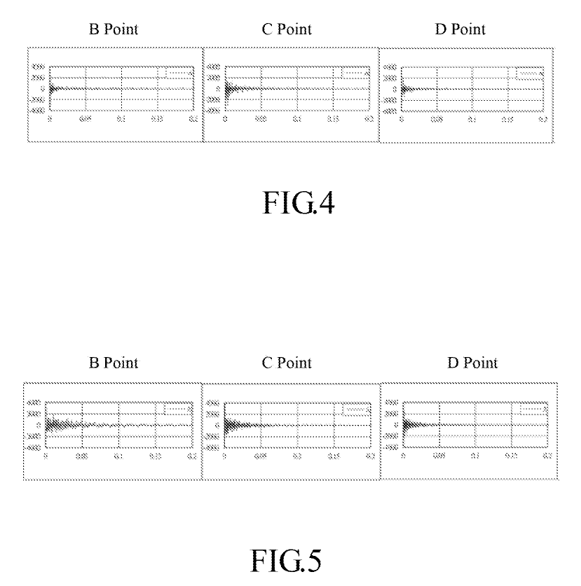

Referring to FIG. 4 and FIG. 5, by comparing the measurement results of point B, point C and point D selected from the shock-absorption goalkeeper ice-hockey stick of the invention with those of three corresponding points on the existing goalkeeper ice-hockey stick, it can be seen that, after point B is knocked, the duration and range of a shock generated at point A are much smaller than the duration and frequency of a shock generated on the corresponding point of the existing goalkeeper ice-hockey stick; after point C is knocked, the duration and frequency of a shock generated at point A are much smaller than the duration and range of a shock generated on the corresponding point of the existing goalkeeper ice-hockey stick; and after point D is knocked, the duration and range of a shock generated at point A are much smaller than the duration and frequency of a shock generated at the corresponding point of the existing goalkeeper ice-hockey stick. On the basis of the above results, compared with the existing goalkeeper ice-hockey stick, the intensity and duration of a shock generated by the shock-absorption goalkeeper ice-hockey stick of the invention are small when a puck coming over at a high speed hits against the shock-absorption goalkeeper ice-hockey stick, the shock-absorption effect of the shock-absorption goalkeeper ice-hockey stick is greatly improved, and players are protected.

According to the shock-absorption goalkeeper ice-hockey stick and the shock test method thereof, wood blocks having a good shock-absorption property are inserted into the joint of the stick handle 1 and the baffle plate 2 and into the tail end of the stick handle 1, and the surfaces of the wood blocks are coated with silicone to further facilitate shock absorption, so that a sense of shock generated when a puck hits against the baffle plate 2 is buffered by the wood blocks and the silicone and is then transmitted to the stick handle 1, the sense of shock is greatly weakened when transmitted to the stick handle 1, and thus, an impact to the wrists and elbows of players is greatly reduced in the goalkeeping and puck blocking process, and the shock-absorption goalkeeper ice-hockey stick can be used more safely and comfortably. In addition, a puck coming over at a high speed can be stopped, the drop point of the puck can be controlled more easily, and the players can have a better performance.

The invention and implementations thereof are illustratively described above. However, the above description is not intended to limit the invention, the embodiment shown in the accompanying drawings is only an illustrate one, and the invention may also have other structures besides the one shown in the accompanying drawings. Similar structures and embodiments designed, under the enlightenment of the illustrative one, by those ordinarily skilled in this field without deviating from the spirit of the invention and without creative work should also fall within the protection scope of the invention.

What is claimed is:

1. A shock-absorption goalkeeper ice-hockey stick, comprising a stick handle (1) and a baffle plate (2), wherein the stick handle (1) is provided with an end having a first wood block (3) tightly inserted therein and an end having a second wood block (5) tightly inserted therein, an outer surface of the first wood block (3) is coated with first silicone (4), an outer surface of the second wood (5) is coated with second silicone (6), and an end, away from the stick handle (1), of the first wood block (3) is fixedly inserted into the baffle plate (2).

2. The shock-absorption goalkeeper ice-hockey stick according to claim 1, wherein the first wood block (3) and the second wood block (5) are made from cork wood or foamed wood.

3. The shock-absorption goalkeeper ice-hockey stick according to claim 1, wherein foam is injected into the stick handle (1), and fiber cloth is laminated onto the foam.

4. A shock test method of the shock-absorption goalkeeper ice-hockey stick according to claim 1, comprising the following steps:
Step 1, correspondingly selecting four points from the first wood block (3), the second wood block (5), the stick handle (1) and the baffle plate (2) of the whole goalkeeper ice-hockey stick, and respectively marking the four points as point A, point B, point C and point D;
Step 2, touching point A on the first wood block (3) by a sensor connected to a shock tester;
Step 3, knocking, by a hard object, point B, point C and point D, recording a shock test chart formed on the shock tester when each of point B, point C and point D are knocked, and respectively marking the shock test charts as a shock test chart of point B, a shock test chart of point C and a shock test chart of point D; and
Step 4, comparing and analyzing the shock test charts obtained in Step 3 with shock test charts of corresponding points of an existing goalkeeper ice-hockey stick.

5. The shock test method of the shock-absorption goalkeeper ice-hockey stick according to claim 4, wherein point A, point B, point C and point D are randomly selected from the corresponding parts in Step 1.
